(19) United States
(12) Patent Application Publication
(10) Pub. No.: US 2024/0129444 A1
(43) Pub. Date: Apr. 18, 2024

(54) ILLUSION-BASED INCREASE OF VEHICLE SIZE

(71) Applicant: International Business Machines Corporation, Armonk, NY (US)

(72) Inventors: Sarbajit K. Rakshit, Kolkata (IN); Vinod A. Valecha, Pune (IN)

(21) Appl. No.: 17/964,756

(22) Filed: Oct. 12, 2022

(51) Int. Cl. H04N 9/31; G06T 7/70; G06V 20/58

(52) U.S. Cl. CPC H04N 9/3188; G06T 7/70; G06V 20/582; B60Q 1/50; G06T 2207/30261; G06V 2201/08

(57) ABSTRACT

A computer-implemented method, in accordance with one aspect of the present invention includes, during movement of a vehicle, monitoring for a predetermined condition corresponding to potential presence of an animal on a roadway. In response to detecting the predetermined condition, a representation of at least a portion of the moving vehicle is projected for virtually increasing a visual size of the vehicle. The projected representation (also referred to as a projection) has a dimension that is greater than the portion of the moving vehicle corresponding to the representation.

### BACKGROUND

The present invention relates to vehicle safety, and more specifically, this invention relates to vehicle-based projection to create the illusion of a larger vehicle.

Collisions between vehicles and wildlife such as deer, birds, etc. clearly conflict with the effort of achieving a safe, environmentally sound, and sustainable transport system. Wildlife-vehicle collisions (WVCs) are becoming more and more common due to the close interaction of human and wildlife habitats worldwide. The large number of globally distributed accidents and the variety of environmental impacts characterize WVCs as intricate and challenging to predict.

A wildlife warning sign is typically a yellow diamond shaped sign with an image of an animal thereon. The sign warns of the possibility of a hazard ahead and advises drivers to be cautious. The sign does not require drivers to slow down to a particular speed, unless there is an adjacent speed limit sign posted as well. Accordingly, many drivers do not slow down, risking collision with an animal.

A WVC almost always causes injury to the animal, and may cause injury to the occupants of the vehicle. Moreover, the vehicle is often damaged. However, the impact of a WVC often goes beyond injury and vehicle damage. For example, the after-effects of a WVC often include damage to roadway infrastructure, the risk of subsequent impacts with the stopped vehicle, traffic delays, etc.

In addition, numerous accidents have occurred when a vehicle swerves to avoid a WVC. For example, drivers have exited the roadway, veered into oncoming traffic, etc. to avoid collision with an animal on the roadway.

One approach contemplated for avoiding WVCs is vehicle-based automatic brake assist. This type of system attempts to apply the vehicle's brakes upon detecting an animal. However, such systems are not always able to reliably detect an animal in the roadway, nor animals that suddenly dart into the roadway from an obscured location. Moreover, when the system does detect an animal, such sudden braking may cause an accident.

It would be desirable to provide a visible illusion that alerts an animal to the vehicle's presence, as well as increases the perceived size of the vehicle, thereby urging the animal to create a sufficient gap between the vehicle and animal to avoid an accident.

### SUMMARY

A computer-implemented method, in accordance with one aspect of the present invention includes, during movement of a vehicle, monitoring for a predetermined condition corresponding to potential presence of an animal on a roadway. In response to detecting the predetermined condition, a representation of at least a portion of the moving vehicle is projected for virtually increasing a visual size of the vehicle. The projected representation (also referred to as a projection) has a dimension that is greater than the portion of the moving vehicle corresponding to the representation.

Such projected representation may make the vehicle appear relatively larger, so that animals can keep a safe distance from the virtually created larger dimensioned vehicle (or virtual portion thereof).

Moreover, other drivers, pedestrians, etc. who may have impaired or poor vision are able to visualize the vehicle due to its larger virtual dimensions, enabling them to keep a safe distance from the moving vehicle.

A computer program product, in accordance with one aspect of the present invention, includes one or more computer readable storage media, and program instructions collectively stored on the one or more computer readable storage media. The program instructions include program instructions to perform the foregoing method.

A system, in accordance with one aspect of the present invention, includes a processor and logic integrated with the processor, executable by the processor, or integrated with and executable by the processor. The logic is configured to cause performance of the foregoing method.

In some approaches, the condition includes receipt of crowdsourced information about an animal on the roadway. This feature may allow the most recent information about actual presence of an animal on the roadway to be received.

In some approaches, the condition includes detection, by a system on the moving vehicle, of an animal in a vicinity of the roadway. Thus, a representation can be projected in the instant it is needed.

In some approaches, a prediction is made as to which side of the moving vehicle has a greater chance of encountering an animal, and in response to predicting a first side of the moving vehicle having a greater chance of encountering an animal, a larger projected representation is created on the first side of the moving vehicle than on an opposite side of the moving vehicle. This aspect provides situationally-appropriate projections.

In some approaches, a level of airborne interference in the vicinity of the moving vehicle is detected. A characteristic of the projected representation is adjusted based on the level, the characteristic being selected from the group consisting of: a dimension, brightness, and color. This feature allows dynamic selection of the projected representation based on ambient conditions.

In some approaches, a position of at least one other moving vehicle adjacent the moving vehicle is detected. The system communicates with the at least one other moving vehicle for creating an aggregate projected representation of at least a portion of one of the moving vehicles in cooperation with a projector of the at least one other moving vehicle. This feature is particularly useful for preventing animals from trying to run between consecutive moving vehicles.

Other aspects of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one aspect of the present invention.

FIG. 2 is a flowchart of a method, in accordance with one aspect of the present invention.

FIG. 3 depicts side and top views of a vehicle and a larger projected representation of the vehicle surrounding the vehicle, in accordance with one aspect of the present invention.

FIG. 4 depicts a top view of a plurality of vehicles and a larger projected representation of the vehicle surrounding the vehicles, in accordance with one aspect of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred aspects of systems, methods and computer program products for vehicle-based projected representation to create the illusion of a larger vehicle. Such projected representation may make the vehicle appear relatively larger, so that animals can keep a safe distance from the virtually created larger dimensioned vehicle (or virtual portion thereof).

In one general approach, a computer-implemented method includes, during movement of a vehicle, monitoring for a predetermined condition corresponding to potential presence of an animal on a roadway. In response to detecting the predetermined condition, a representation of at least a portion of the moving vehicle is projected for virtually increasing a visual size of the vehicle. The projected representation has a dimension that is greater than the portion of the moving vehicle corresponding to the representation.

In another general approach, a computer program product includes one or more computer readable storage media, and program instructions collectively stored on the one or more computer readable storage media. The program instructions include program instructions to perform the foregoing method.

In another general approach, a system includes a processor and logic integrated with the processor, executable by the processor, or integrated with and executable by the processor. The logic is configured to cause performance of the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code 150 for increasing virtual dimensions of a vehicle. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

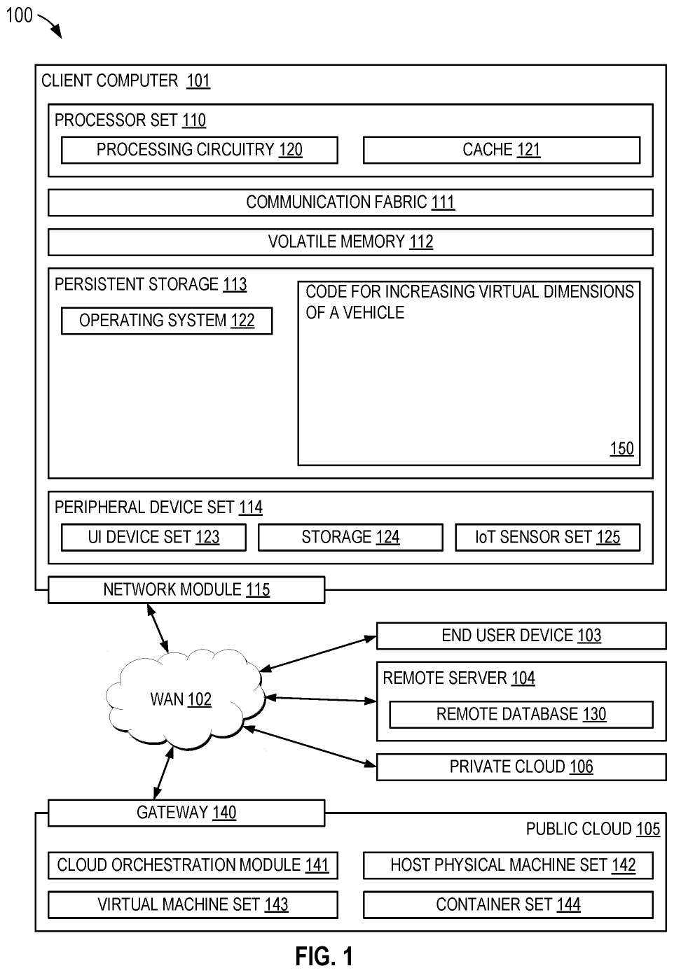

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

As noted above, WVCs and near-WVCs are responsible for vehicle damage and grave bodily injury. Presented herein are various aspects of a system and corresponding methodology for increasing virtual dimension of a vehicle by enabling projected representation, preferably via one or more holographic projectors, from one or more sides of the vehicle to avoid accidents.

While much of the description presented herein is described with reference to wildlife, it should be noted that the system and methodology presented herein are equally and equivalently applicable to preventing collisions with pedestrians, bicyclists, and domesticated animals such as cows, sheep, goats, pigs, fowl, etc.

In addition, while much of the description presented herein is described with reference to an automobile traveling along a roadway, the system and methodology presented herein are equally and equivalently applicable to other types of vehicles and their respective surface of transit. Other types of vehicles include trains, boats, cycles, aircraft, etc. Accordingly, the described “roadway” may encompass railroad tracks, waterways, cycle paths, etc. in various aspects of the present invention.

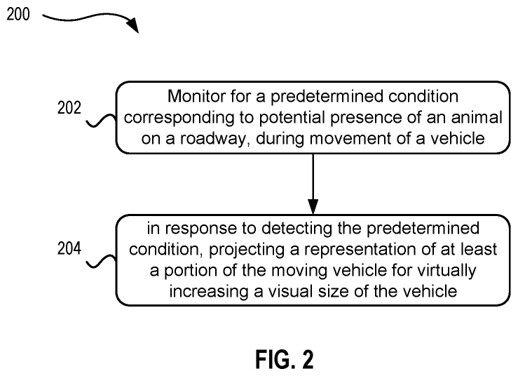

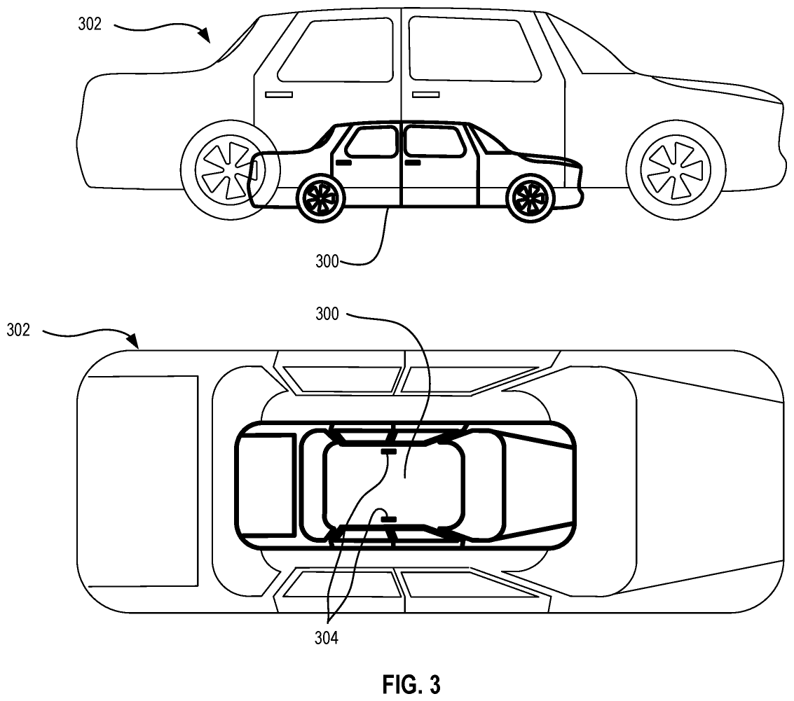

Now referring to FIG. 2, a flowchart of a method 200 is shown according to one aspect of the present invention. The method 200 may be performed in accordance with the present invention in any of the environments depicted in FIGS. 1 and 3, among others, in various approaches. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various approaches, the method 200 may be partially or entirely performed by a vehicle-mounted system, or some other device having one or more processors therein. The processor, e.g., processing circuit(s), chip(s), and/or module(s) implemented in hardware and/or software, and preferably having at least one hardware component may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 2, method 200 may initiate with operation 202, where during movement of a vehicle, monitoring is performed for a predetermined condition corresponding to potential presence of an animal on a roadway.

The condition monitored may be any condition indicative of potential presence of an animal on and/or near a roadway. In some aspects, the condition is based on historical information, e.g., from a database, crowdsourced information, a previously-saved location, etc. In other aspects, the condition indicative of potential presence of an animal includes detection of the actual presence of an animal on and/or adjacent the roadway.

In one approach, the condition includes receipt of crowdsourced information about an animal on the roadway. For example, a website, service, etc. having such crowdsourced information may be queried by the system, or the crowdsourced information pushed to the system. The crowdsourced information may be derived from information submitted by other drivers who see or otherwise encounter animals on a roadway. For instance, a map service may allow submission, by its users, of a notification that the user detected an animal, preferably along with an approximate location of the detection. In another approach, systems similar to the presently-described system may provide relevant data to a crowdsourcing database for distribution to the present system, such as detection of an animal on or near a roadway.

In another approach, the condition includes detection of a road sign having an image of an animal thereon. Typically, road signs are placed in areas where WVCs are common. Presence of such a road sign may be detected in output of a camera that captures images and/or video of the roadway. Equivalently, the locations of such road signs may be correlated with the present location of the vehicle, and the presence of one such road sign nearby may be inferred from the correlation.

In yet another approach, the condition includes detection, by the system on the moving vehicle, of an animal in a vicinity of the roadway, such as on the roadway, adjacent the roadway, running alongside the roadway, running toward the roadway, etc. For example, the presence of the animal may be recognized during analysis of output of a camera mounted on the vehicle. In another approach, the presence of the animal may be recognized based on output of a vehicle-integrated animal and/or pedestrian detection system.

Any other condition that would become apparent to one skilled in the art after reading the present disclosure may be monitored.

Moreover, multiple conditions may be monitored while the vehicle is in operation, any one of which may indicate presence of an animal. In some approaches, two conditions must be met to satisfy operation 202.

In operation 204 of FIG. 2, in response to detecting the predetermined condition, a representation of at least a portion of the moving vehicle is projected for virtually increasing a visual size of the vehicle, the projected representation having a dimension (e.g., height, length, width, volume, etc.) that is greater than the portion of the moving vehicle corresponding to the representation. Such projected representation may make the vehicle appear relatively larger, so that animals can keep a safe distance from the virtually created larger dimensioned vehicle (or virtual portion thereof).

Moreover, other drivers, pedestrians, etc. who may have impaired or poor vision are able to visualize the vehicle due to its larger virtual dimensions, enabling them to keep a safe distance from the moving vehicle.

FIG. 3 depicts side and top views of a vehicle 300 and a larger projected representation 302 of the vehicle surrounding the vehicle 300, in accordance with one aspect of the present invention. As an option, the present vehicle 300 may be implemented in conjunction with features from any other embodiment listed herein, such as those described with reference to the other FIGS. Of course, however, such vehicle 300 and others presented herein may be used in various applications and/or in permutations which may or may not be specifically described in the illustrative embodiments listed herein. Further, the vehicle 300 presented herein may be used in any desired environment.

In one approach, the projecting includes using a holographic projector 304 configured to project a holographic image (representation 302) representing a larger version of at least a portion of the moving vehicle, and preferably a larger version of the entire moving vehicle. Holographic projectors 304 of a type known in the art may be used. Moreover, many holographic projectors 304 may be present on the vehicle 300 and may work together to form a larger projected representation, e.g., each may project a portion of a projected representation of the vehicle.

In some approaches, the holographic image closely matches the contours of the model of the vehicle. In other approaches, the holographic image may not match the model of the vehicle, but may instead be a general image corresponding to a similar portion of the vehicle, e.g., the vehicle may be a specific model of sedan, but the holographic image may include a generalized shape of a sedan.

Preferably, multiple projectors are used to project a holographic image around multiple sides of the moving vehicle, and in particularly preferred approaches, around all sides of the moving vehicle.

The shape, one or more dimensions (length, width, height, etc.), color, brightness, etc. of the projected representation may be fixed, variable, dynamically changing, etc.

Characteristics such as size of the representation may be selected based on one or more predefined factors. Any factor that would become apparent to one skilled in the art after reading the present disclosure may be used. Illustrative factors include: velocity of the moving vehicle, dimensions of the roadway, relative position of the moving vehicle on the roadway, visual field of view adjacent the moving vehicle, visibility in the atmosphere surrounding the moving vehicle, and actual detection of an animal on the roadway (e.g., via a sensor, optical recognition of known type, etc.), a number of animals detected on a roadway, weather (e.g., retrieved from a weather service), etc. For example, the faster the vehicle is moving, the larger the projected representation may be to provide more notice that the vehicle is approaching.

In one example, a level of airborne interference in the air in the vicinity of the moving vehicle, e.g., due to fog, dust, smoke, etc. may be detected, and one or more of the aforementioned characteristics of the projected representation may be selected, adjusted, etc. While such airborne interference tends not to limit visibility of vehicles and pedestrians on the roadway, it may also enhance the visibility of a projected representation by reflecting light emitted form the projectors. Accordingly, in one approach, the system may select characteristics such as level of brightness and color of the holographic projected representation around the vehicle so that the virtual dimension of the vehicle is increased, and the same is visible for longer distances.

The system may also include a mechanism for manipulating air in the vicinity of the vehicle. Examples include a midair haptic module, an air blower (e.g., fan, turbine, etc.), etc. In one approach, the mechanism stirs up particles, e.g., dust, in the vicinity of the vehicle to provide airborne particles that reflect the projected representation.

In one approach, the size of the representation is selected based on factors such as: velocity of the moving vehicle, characteristics of the roadway (e.g., dimensions of the roadway such as road width, presence of a curve and/or hill, banking of the roadway, etc.), relative position of the moving vehicle on the roadway, and visibility in the environment around the moving vehicle (e.g., due to fog, smoke or dust in the air; due to ambient conditions, e.g., dusk; etc.). In general, the size and/or brightness of the projected representation may be increased with worsening visibility due to any factor and/or increasing velocity.

One approach includes predicting which side of the moving vehicle has a greater chance of encountering an animal, and in response to predicting a first side of the moving vehicle having a greater chance of encountering an animal, creating a larger projected representation on the first side of the moving vehicle than on an opposite side of the moving vehicle, including creating a smaller projection on the opposite side, or creating no projection on the opposite side. This approach may be useful in situations where a fence runs along one side of the roadway, making it less likely that an animal would be present on that side of the roadway.

In any approach herein, artificial intelligence may be used to make any decision, selection, etc. noted herein. Inputs, techniques, etc. that would become apparent to one skilled in the art upon reading the present disclosure may be used for and/or by the artificial intelligence.

Moreover, when installed on an autonomous vehicle, the system may create an extended vehicle boundary, e.g., making the vehicle look longer within the lane of the vehicle, so that drivers of manually driven vehicles see the extended boundary and will keep a safe distance away to avoid accidents.

In one approach, a position of at least one other moving vehicle adjacent the moving vehicle is detected. The system communicates with a projection system of the at least one other moving vehicle for creating an aggregate projected representation of at least a portion of one of the moving vehicles in cooperation with a projector of the at least one other moving vehicle.

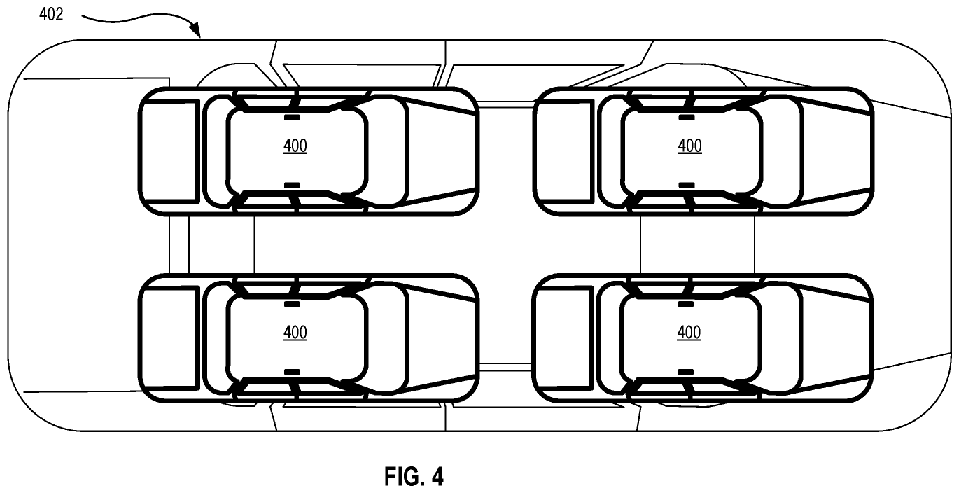

FIG. 4 depicts a top view of a plurality of vehicles 400 and a larger projected representation 402 of the vehicle surrounding the vehicles 400, in accordance with one aspect of the present invention. As an option, the present vehicles 400 may be implemented in conjunction with features from any other embodiment listed herein, such as those described with reference to the other FIGS. Of course, however, such vehicles 400 and others presented herein may be used in various applications and/or in permutations which may or may not be specifically described in the illustrative embodiments listed herein. Further, the vehicles 400 presented herein may be used in any desired environment.

The projection systems of the vehicles may collaborate with each other, e.g., via a network, and share their relative position, speed, etc. Accordingly, an aggregated increased dimension of the vehicles can be created with holographic projections, so that the animals, pedestrians, other drivers, etc. can keep distance from the aggregated dimension of the vehicles. This feature is especially useful for animals such as stray dogs that tend to try to run across a road between moving vehicles. The larger aggregate representation appears as a larger vehicle, thus disguising the gap between forward and aft vehicles, and thereby dissuading the animal from attempting to run between vehicles.

It will be clear that the various features of the foregoing systems and/or methodologies may be combined in any way, creating a plurality of combinations from the descriptions presented above.

It will be further appreciated that aspects of the present invention may be provided in the form of a service deployed on behalf of a customer to offer service on demand.

The descriptions of the various aspects of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A computer-implemented method, comprising:
during movement of a vehicle, monitoring for a predetermined condition corresponding to potential presence of an animal on a roadway; and
in response to detecting the predetermined condition, projecting a representation of at least a portion of the moving vehicle for virtually increasing a visual size of the vehicle, the projected representation having a dimension that is greater than the portion of the moving vehicle corresponding to the representation.

2. The computer-implemented method of claim 1, wherein the condition includes receipt of crowdsourced information about an animal on the roadway.

3. The computer-implemented method of claim 1, wherein the condition includes detection of a road sign having an image of an animal thereon.

4. The computer-implemented method of claim 1, wherein the condition includes detection, by a system on the moving vehicle, of an animal in a vicinity of the roadway.

5. The computer-implemented method of claim 1, wherein the projecting includes using a holographic projector configured to project a holographic image representing a larger version of at least a portion of the moving vehicle.

6. The computer-implemented method of claim 5, wherein the holographic image includes a larger version of the entire moving vehicle.

7. The computer-implemented method of claim 1, comprising selecting a size of the representation based on a factor selected from the group consisting of: velocity of the moving vehicle, characteristics of the roadway, relative position of the moving vehicle on the roadway, visual field of view adjacent the moving vehicle, visibility in the atmosphere surrounding the moving vehicle, and actual detection of an animal on the roadway.

8. The computer-implemented method of claim 1, comprising selecting a size of the representation based on factors including velocity of the moving vehicle, dimensions of the roadway, relative position of the moving vehicle on the roadway, and visibility in the environment around the moving vehicle.

9. The computer-implemented method of claim 1, comprising predicting which side of the moving vehicle has a greater chance of encountering an animal, and in response to predicting a first side of the moving vehicle having a greater chance of encountering an animal, creating a larger projected representation on the first side of the moving vehicle than on an opposite side of the moving vehicle.

10. The computer-implemented method of claim 1, comprising detecting a level of airborne interference in the vicinity of the moving vehicle; and adjusting a characteristic of the projected representation, the characteristic being selected from the group consisting of: a dimension, brightness, and color.

11. The computer-implemented method of claim 1, comprising detecting a position of at least one other moving vehicle adjacent the moving vehicle; and
communicating with the at least one other moving vehicle for creating an aggregate projected representation of at least a portion of one of the moving vehicles in cooperation with a projector of the at least one other moving vehicle.

12. A computer program product, the computer program product comprising:
one or more computer readable storage media, and program instructions collectively stored on the one or more computer readable storage media, the program instructions comprising:
program instructions to monitor for a predetermined condition corresponding to potential presence of an animal on a roadway during movement of a vehicle; and
program instructions to project, in response to detecting the predetermined condition, a representation of at least a portion of the moving vehicle for virtually increasing a visual size of the vehicle, the projected representation having a dimension that is greater than the portion of the moving vehicle corresponding to the representation.

13. The computer program product of claim 12, wherein the condition includes receipt of crowdsourced information about an animal on the roadway.

14. The computer program product of claim 12, wherein the condition includes detection of a road sign having an image of an animal thereon.

15. The computer program product of claim 12, wherein the condition includes detection, by a system on the moving vehicle, of an animal in a vicinity of the roadway.

16. The computer program product of claim 12, wherein the projecting includes using a holographic projector configured to project a holographic image representing a larger version of at least a portion of the moving vehicle.

17. The computer program product of claim 12, comprising program instructions to select a size of the representation based on a factor selected from the group consisting of: velocity of the moving vehicle, characteristics of the roadway, relative position of the moving vehicle on the roadway, visual field of view adjacent the moving vehicle, visibility in the atmosphere surrounding the moving vehicle, and actual detection of an animal on the roadway.

18. The computer program product of claim 12, comprising program instructions to select a size of the representation based on factors including velocity of the moving vehicle, dimensions of the roadway, relative position of the moving vehicle on the roadway, and visibility in the environment around the moving vehicle.

19. The computer program product of claim 12, comprising program instructions to predict which side of the moving vehicle has a greater chance of encountering an animal, and in response to predicting a first side of the moving vehicle having a greater chance of encountering an animal, creating a larger projected representation on the first side of the moving vehicle than on an opposite side of the moving vehicle.

20. A system, comprising:
a processor; and
logic integrated with the processor, executable by the processor, or integrated with and executable by the processor, the logic being configured to:
monitor, during movement of a vehicle, for a predetermined condition corresponding to potential presence of an animal on a roadway; and
in response to detecting the predetermined condition, project a representation of at least a portion of the moving vehicle for virtually increasing a visual size of the vehicle, the projected representation having a dimension that is greater than the portion of the moving vehicle corresponding to the representation.
